(19) United States
(12) Patent Application Publication
(10) Pub. No.: US 2018/0060819 A1
(43) Pub. Date: Mar. 1, 2018

(54) DYNAMIC DOCUMENT APPROVAL SYSTEM AND METHOD

(71) Applicant: STAMPLI LTD., Ghivat Shmuel (IL)

(72) Inventors: Eyal FELDMAN, Sunnyvale (CA); Ofer FELDMAN, Ghivat Shmuel (IL)

(21) Appl. No.: 15/525,065

(22) PCT Filed: Jan. 3, 2016
(86) PCT No.: PCT/IB16/50008

§ 371 Date: May 7, 2017

Related U.S. Application Data
(60) Provisional application No. 62/108,108, filed on Jan. 27, 2015.

(51) Int. Cl. G06Q 10/10; G06Q 10/06; G06Q 30/04; H04L 12/58; G06F 17/22; G06F 17/30

(52) U.S. Cl. CPC G06Q 10/107; G06Q 10/0637; G06Q 10/103; G06F 17/30011; H04L 51/08; G06F 17/2288; G06Q 30/04

(57) ABSTRACT

The subject matter discloses a system that enables approvers of a document to add one or more approvers to any position the list, to cause the approving process to restart from a certain approver and to post questions to other users. The history of all actions that took place in the approving process is clearly displayed to the users in chronological order, describing the action, the requestor, the requested user and all related texts.

### FIELD OF THE INVENTION

The present disclosure relates in general to the field of document approval systems.

### BACKGROUND OF THE INVENTION

The process of approving documents in organizations is typically complicated and time consuming. Typically, the process is manual and paper based or automatic and is based on rigid or complicated and complex workflow tools and procedures.

### SUMMARY OF THE INVENTION

Embodiments of the invention provide a dynamic document approval system. The approval process requires flexible yet managed and visible collaboration between more than one person across the organization. This collaboration includes the ability of the approvers to dynamically decide who else needs to approve the document before or after them and to ask questions and receive answers from other users. For example, in the case of invoice approval, a first approver can ask other users from his team questions regarding the service related to the invoice. This approver may ask for preapproval from the person who has answered that he has received the service personally. This person may ask another user what was the order number. The first approver then may decide to pass the invoice to his boss for additional approval, and his boss may decide to pass the invoice to his department's budget controller for additional approval. Additionally the finance department may like to understand the flow that has happened in order to decide if the approval process was sufficient or requires more approvers. In another example, a final design document may entail the approval of several people from several departments who are involved in the design.

The present disclosure provides a system that enables approvers of a document to add one or more approvers in any position in the list, to cause the approving process to restart from a certain approver and to post questions. The history of all actions that took place in the process is displayed to the users and is also analyzed by the system.

One problem disclosed by the present disclosure is how to provide a flexible, reliable and dynamic process for approving documents. In many cases an approval process requires two elements: 1. a dynamic “on the fly” collaboration between people while enabling them to communicate freely and to understand the context and the background of the process. 2. a managed and controllable process where management can control and moderate the process. Workflow automatic tools lacks the first element and Manual paper process lacks the second. Thus, there is a need for a system and a process that enables both elements in one solution.

One solution is a system that enables any approver in the list to post questions or requests to other users and to insert one or more approvers in any position in the list of approvers. Such a solution provides a distributed system in which each approver can add more approvers to the list and may even cause the approving process to revert to a certain position.

A position of the new approver may be before the position of the current approver in the list. In such a case, the approving process may restart from the position of the new approver, which may cause the reapproving of the process by approvers following the new approver. In another case, a position of the new approver may be after the position of the current approver. In such a case, the approving process may continue to the next approver in the list and will eventually approach the new approver.

The terms collaborator and approver are used herein interchangeably.

The new approver may also be selected from outside the organization.

According to some embodiments, collaborators, including new collaborators may automatically gain access rights for reviewing information related to the document, even after approving the document.

One other solution is providing a mechanism of asking questions and for responding to questions such that the questions and responses related to a specific invoice are presented to an approver or to any other person involved in the process while dealing with the invoice and enabling him to take the correct decisions and to avoid asking questions that have already been asked.

According to some embodiments all the actions including approving, questions, answers and tasks such as field update request, taken by all users are presented to any of the users while handling the document in a chronological order while each answer is displayed next to its related question.

One exemplary embodiment of the disclosed subject matter is a document approving method comprising: at a system having a server and a data repository; said data repository comprising data associated with a document, said data comprising an image of said document, a list of users and a list of selected approvers; notifying a current approver about an approving request; wherein said current approver being selected from said list of selected approvers by an approval process; wherein said approval process traversing said list of selected approvers; downloading to a computer device of said current approver said data associated with said document; downloading to a computer device of said current approver control elements associated with said document; wherein said control elements being for selecting an approver from said list of users to be inserted in said selected approvers list; or wherein said control elements being for restarting said approval process from a certain position in said list of selected approvers; and as a result of said notifying, receiving from said computer device a request for inserting a new approver in said selected approver list; said request comprises a position for inserting said new approver; and in response to said request, inserting said new approver in said selected approvers list in accordance with said position, wherein a preceding position causing said approval process to restart said traversing from said preceding position, thereby causing said approval process to select said new approver as the current approver; and wherein a proceeding position causing said approval process to continue the traversing from a successive position to a position of said current approver and to eventually selecting said new approver as the current approver; or as a result of said notifying, receiving from said computer device a request for reverting said approval process from a certain position in said list of approvers wherein said request causing said approving process to restart from said certain position. According to some embodiments said document being an invoice. According to some embodiments, the method further comprises automatic attaching a purchase order printout to the invoice screen as a result of entering a purchase order number matching said printout purchase order number. According to some embodiments, the method further comprising presenting approvals, events, requests, questions and responses, related to said document in chronological order; wherein an answer being displayed next to question related to said answer. According to some embodiments, the method further comprising providing a queue of a plurality of said documents for enabling the retrieving of said documents from said queue by a plurality of computer devices to be processes by a plurality of authorize person; and further comprising synchronizing the process to allow the processing of a single document by single person. According to some embodiments, the method further comprising analyzing the history of approvals; said analyzing being for predicting time required to finalize the approval process. According to some embodiments the notifying comprises inserting an inbox item to an inbox of said current approver and further comprising retaining said inbox item while current approver sends and receives messages related to said inbox and further comprising removing said inbox item from said inbox as a result of receiving an approval event from said approver and wherein task description of said inbox item being adapted to the approval event. According to some embodiments the method further comprising providing access right to a user from said list of users for reviewing information related to said document, wherein said access right being valid even after handling said document by said user. According to some embodiments said notifying further comprising inserting an inbox item to an inbox of said current approver; wherein said downloading said data and said control elements being as a result of opening said inbox item by said current approver. According to some embodiments said data further comprising, a list of questions asked by one or more of said users and a list of responses to said questions; and wherein the method further comprising; notifying a user from said list of users about a question to be responded by said user; said question being associated with a document; downloading to a computer device of said user said data associated with said document; downloading to said computer device of said user control elements associated with said document, said control elements being for enabling said user to post a second question to a second user of said list of users; or to response to said question; and as a result of said notifying, receiving from said computer device a request for posting said second question to said second user from said list of users, or, as a result of said notifying, receiving from said computer device a response to said question; and in response to said second question notifying said second question to said second user to thereby enabling said second user to reposed to said second question; or as a result of said response associating said response with said document in said data repository thereby enabling users from said user list viewing said question and said response. According to some embodiments The method of claim 10, wherein said notifying said question further comprising a selected portion of said image of said document; wherein said selected portion being related to said question. According to some embodiments said notifying comprises adding an inbox item to an inbox of said user; and further comprising removing said inbox item from said inbox as a result of receiving said response. According to some embodiments said document being an invoice. According to some embodiments said downloading said data and said control elements being as a result of opening said inbox item by said user. According to some embodiments the method further comprising presenting to current viewer of said document actions related to said document taken by approvers until that time in chronological order wherein an answer being displayed next to a question being related to said question.

One other exemplary embodiment of the disclosed subject matter is A document approving method comprising: at a system having a server and a data repository; said data repository comprising data associated with a document, said data comprising an image of said document, a list of users, a list of selected approvers, approval events, queries to a user from said users and responses to queries; notifying a current approver about a request; and downloading to a computer device of said current approver said data associated with said document; wherein said downloading enabling presenting said data in chronological order and further enabling presenting a response from said responses next to a query from said of queries; wherein said query being related to said response. According to some embodiments said current approver being selected from said list of selected approvers by an approval process; wherein said approval process traversing said list of selected approvers.

One other exemplary embodiment of the disclosed subject matter is A non-transitory computer-readable storage medium for storing instructions, the instructions when executed by a processor, at a system having a server and a data repository; said data repository comprising data associated with a document, said data comprising an image of said document, a list of users and a list of selected approvers, causes the processor to: notifying a current approver about an event of approving request; wherein said current approver being selected from said list of selected approvers by a traversing process; downloading to a computer device of said current approver said data associated with said document; downloading to a computer device of said current approver control elements associated with said document; wherein said control elements being for enabling said current approver to approve said document; wherein said control elements being for selecting an approver to be inserted in said selected approvers list; wherein said selecting being from said list of users and as a result of said notifying, receiving from said computer device a request for inserting a new approver in said selected approver list; said request comprises a position for inserting said new approver; and in response to said request, inserting said new approver in said selected approvers list in accordance with said position, wherein a preceding position causing said traversing process to continue the traversing from said preceding position, thereby to select said new approver as the current approver; and wherein a proceeding position causing said traversing process to continue the traversing from a successive position and to eventually selecting said new approver as the current approver.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows block diagram of a system for dynamic document approving, in accordance with some exemplary embodiments of the subject matter;

FIGS. 2a, 2b and 2c show a flowchart diagram of a method for dynamic document approving, in accordance with some exemplary embodiments of the disclosed subject matter;

FIGS. 3a, 3b and 3c show a flowchart diagram of a scenario of dynamic invoice approving, in accordance with some exemplary embodiments of the disclosed subject matter; and

FIG. 4 shows an exemplary inbox item, in accordance with some exemplary embodiments of the disclosed subject matter.

### DETAILED DESCRIPTION

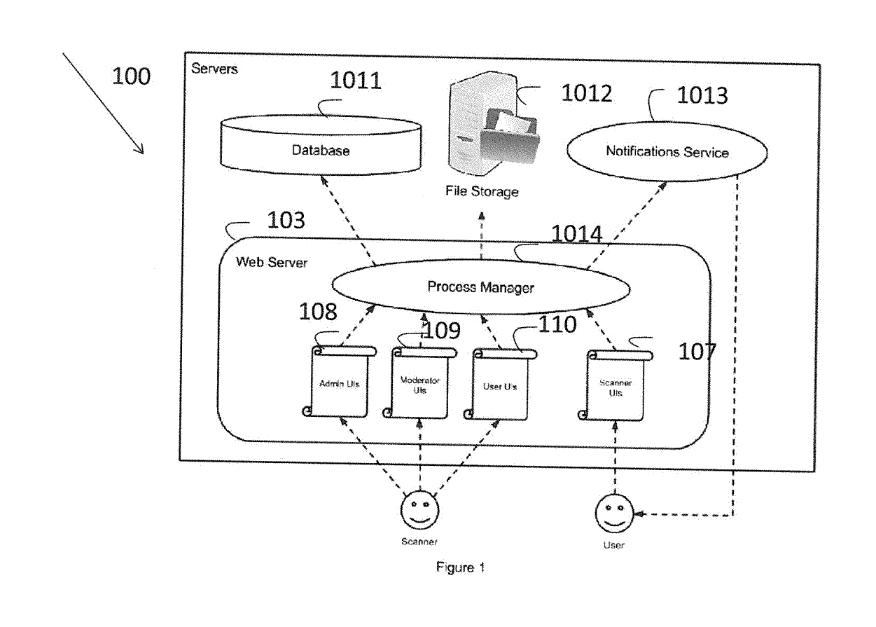

FIG. 1 shows block diagram of a system for automatic invoice approving, in accordance with some exemplary embodiments of the subject matter.

System 100 includes database 1011, file storage 1012, a notification service 1013, and a web server 103.

The web sever 103 includes process manager 1014, scanner UI (user interface) 107, admin UI 108 (user interface), Moderators UI (user interface) 109 and user UI (user interface) 110.

System 100 may communicate with the computer devices of the users of the system via an internet network. Such users may be an Approver, a Dispatcher, an Administrator, an Indexer, a Processor and a Manager.

The Database 1011 is configured to store data associated with the documents and with the users. The data associated with the documents may include a list of selected approvers, a list of users, a list of questions asked by one or more of the users; a list of responses to the questions and a list of approval events. The term list refers herein to a collection of data items and meta-data related to the data items. The list may be empty.

The File storage 1012 includes files such as images of the documents, various attachments and configurations files.

The Notification service 1013 handles the notifications that are sent to the user. Examples of such notifications are SMS, email and push notifications.

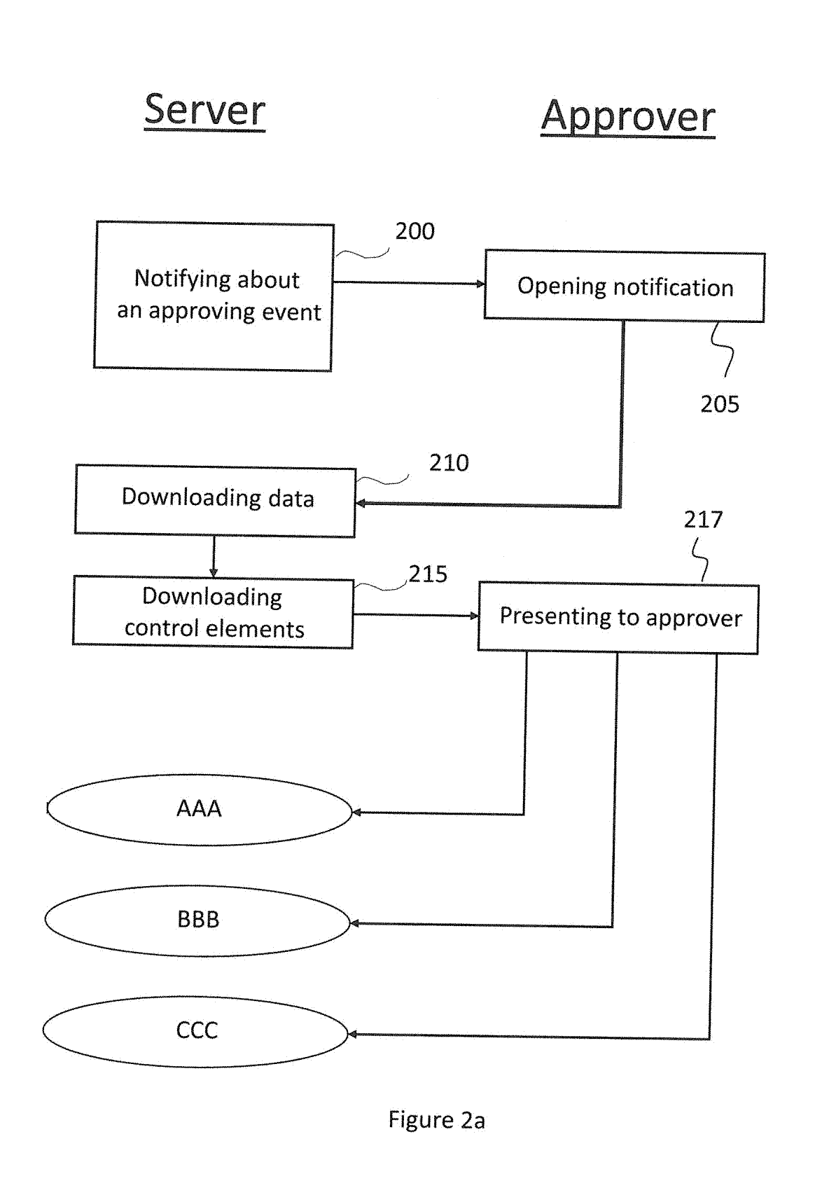

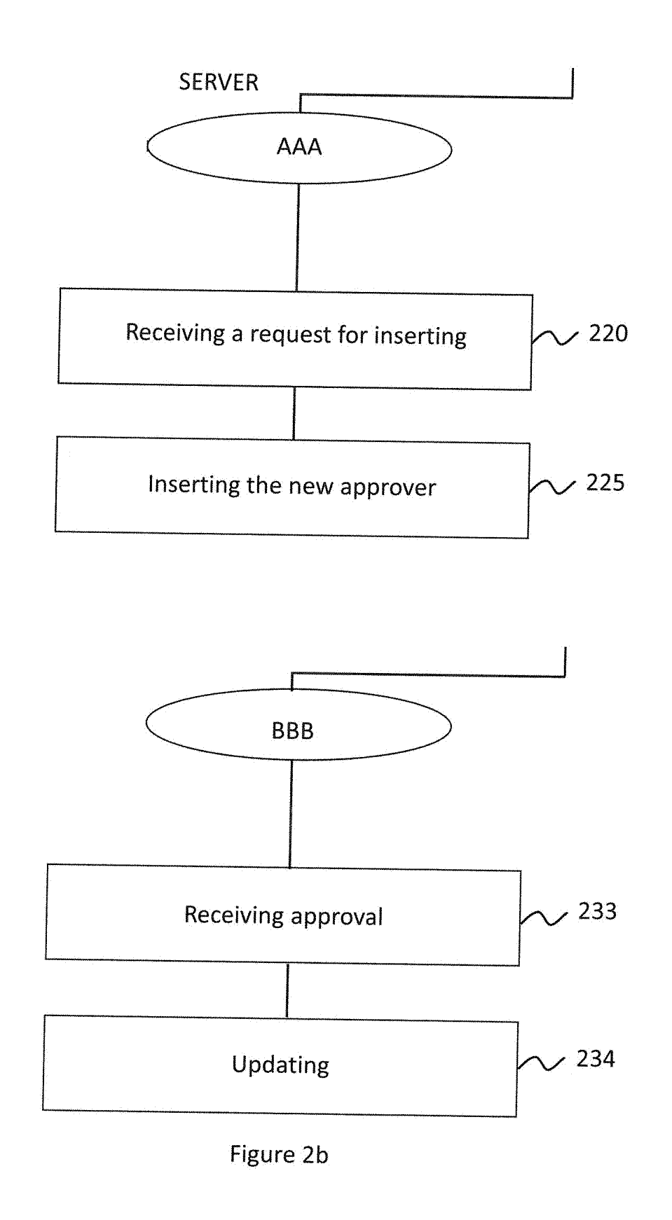

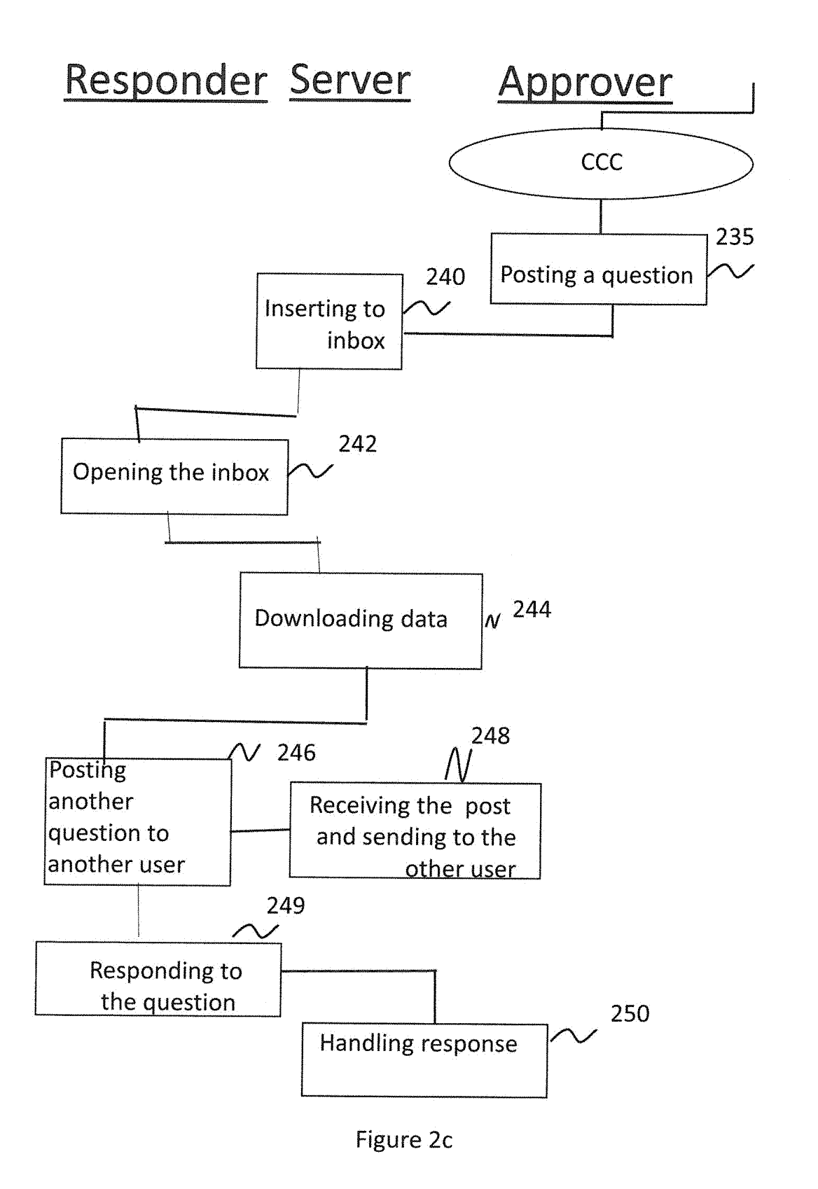

The Process manager 1014 is configured for managing of dynamic document approving process. The process is explained in greater details in FIG. 2.

The Scanner UI (user interface) 107, admin UI 108 Moderators UI 109 and user UI 110 handle the user interface and includes screens to be presented to various users. The scanner UI (user interface) 107 handles the user interface of the user who scans the documents, the admin UI 108 handles the user interface of the administrator, the Moderators UI and user UI 100 handles the user interface of the users. The moderators may be a dispatcher, a processor or a manager.

FIGS. 2a, 2b and 2c show a flowchart diagram of a method for dynamic document approving, in accordance with some exemplary embodiments of the disclosed subject matter.

According to some embodiments, the processing of the document includes associating the document with a list of approvers and starting the approving process. Referring now to the drawing:

At block 200, the approving process that is part of the process manager described in FIG. 1 notifies a current approver about an event of approving request. The current approver is the approver from the list of approvers that currently has to approve a document. The notification may be by inserting an inbox item to the inbox of the user and optionally by sending email. The inbox item includes, inter alia, a link to the document, specific details from the document which are relevant for this approver, previous actions related to the document that are relevant to this approver and current status of this document which is relevant to the approver. The text of the current status may be in the form “waiting for your approval for document xxx” wherein xxx is the serial number of the document”. Clicking retrieves the approver UI, thus directly allows the user to handle the document.

The notification may also be sent as a mail message.

At block 205, the current approver opens the inbox item, from the inbox. It should be noted that the document image page related to the inbox item can also be opened from a link in the notification item

At block 210, which occurs as a result of opening the inbox item by the current approver, the server downloads data related to the document to a computer device of the current approver. The data includes an image of the document, a list of users and a list of selected approvers. The data may also include a list of questions asked by one or more of the users, a list of responses to the questions, file attachments and a list of comments commented by other users.

At block 215, the server downloads to a computer device of the current approver control elements associated with the document. The control elements enable the current approver to approve the document or to reject the approval. The control elements also enable the user to select one or more new approvers from a list of users (or manually add users) and to instruct the process manager to insert the new approvers in various positions in the selected approvers list. The control elements also enable the current approver to cause the approving process to restart from a certain position in the list or to post a question to other users or to add comments.

At block 217, the data and the control elements are presented to the approver.

Blocks 220 and 225 are performed if the user selects to add new approvers to the list.

At block 220, the server receives from the computer device of the current approver a request for inserting one or more new approvers in the selected approvers list. The request includes positions for inserting the new approvers. For example if the list of selected approvers includes eight users and the current approver is positioned in the 4^{th} position in the list, the request may instruct to position a first new approver after the second position and a second new approver after the sixth position in the list. At block 225, the server inserts the new approvers in the selected approvers list in accordance with the position. In the example described in block 220 the approvers list includes ten users after inserting the new approvers.

A preceding position, such as the position of the first new approver, will cause the approval process to restart the traversing from the preceding position. In the example, the process will restart from the third position causing the requesting an approval from the first new approver.

A proceeding position will cause the approval process to continue the traversing from a successive position. For example, if the current approver is positioned in the 4^{th} position in the list and if only one approver is inserted after the 5^{th} position (taking the 6^{th} position), then the approving process will continue from the user in the 5^{th} position and after receiving an approval from this user, the process will proceed to the new approver.

Blocks 233 and 234 are performed if the current approver selects to approve the document.

At block 233, the server receives the approval.

At block 234, the server updates the data repository and removes the inbox item from the inbox of the current approver.

Blocks 235, 240, 242, 244, 246, 248, 249 and 250 occur if the current approver has selected to post a question to another user.

At block 235, the current approver posts a question to one of the users.

At block 240, the server causes the notification of the question to be inserted as an inbox item in the inbox of the requested users and optionally to be sent by mail to the requested users. The status that is displayed in the notification item may be in the form of “you have a question from user yyy related to document xxx” wherein xxx is the serial number of the document and yyy is the name of the requestor”. The inbox item may contain a link to the document which, upon clicking, retrieves the relevant UI thus directly allowing the user to see the document and answer the question.

Blocks 242 and 244 illustrate the handling of a response from one of the responders;

At block 242, the responder opens the inbox item of the question from the inbox.

At block 244, which occurs as a result of opening the inbox item of the question, the server downloads to a computer device of the responder data associated with the document. The data includes the image of the documents, list of users, list of selected approvers and approvals, list of rejections, list of questions already asked and responses to the questions and the current question and the identity of the requestor. According to some embodiments, all the actions including approving, questions and answers and requests, taken by all users are presented to any of the users in a chronological order while each answer is displayed next to its related question. The data enables the responder to provide a response that takes into consideration history of approvals and previous responses. In some cases, the requestor marks a segment in the document in order to focus the responder to this segment while answering the question. In such a case, the marking of the segment is also downloaded and is presented to the responder and all future viewing users.

At block 246, the responder posts another question.

At block 248, which occurs if the responder has decided to post another question, the server receives a request for posting a second question to a second user from the list. The server notifies the second user about the second question enabling the second user to reposed to the second question

At block 249, the requestor responses to the question that was posted to him.

At block 250, which occurs if the requestor has responded to the question, the server associates the response with the document enabling other users, such as other approvers, to view the question and the response. The server also removes the data item related to the question from the inbox of the responder and inserts a data item related to the response to the inbox of the requestor. The text in the status filed of this data item may be in the form “zzz has answered your question related to document xxx” wherein xxx is the name of the document and zzz is the name of the responder. The data item may contain a link to the document, which, upon clicking, retrieves the relevant UI thus directly allowing the user to see the document and the answer to his question.

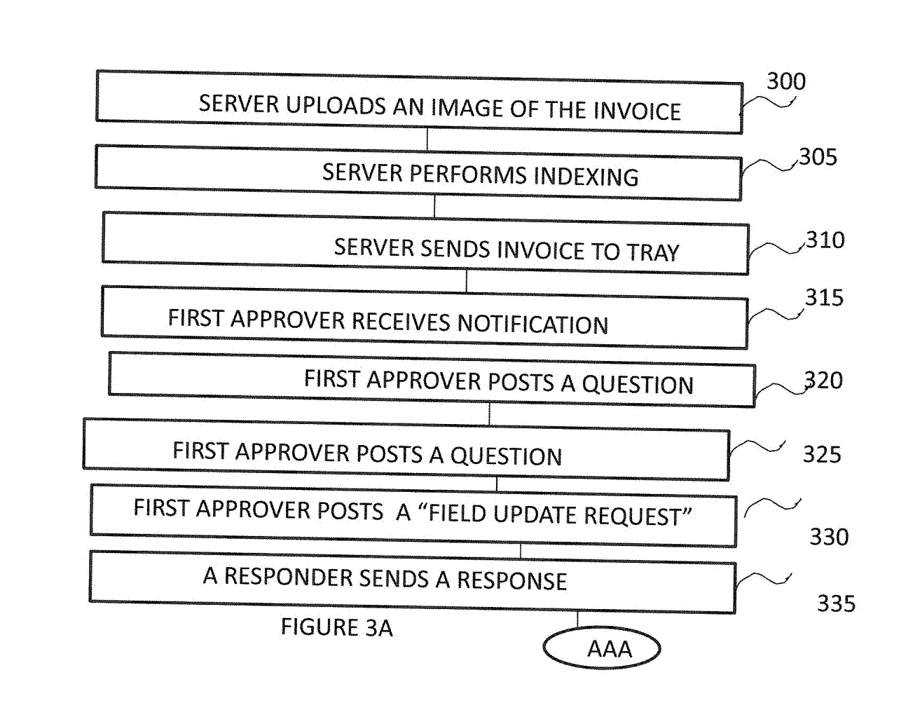

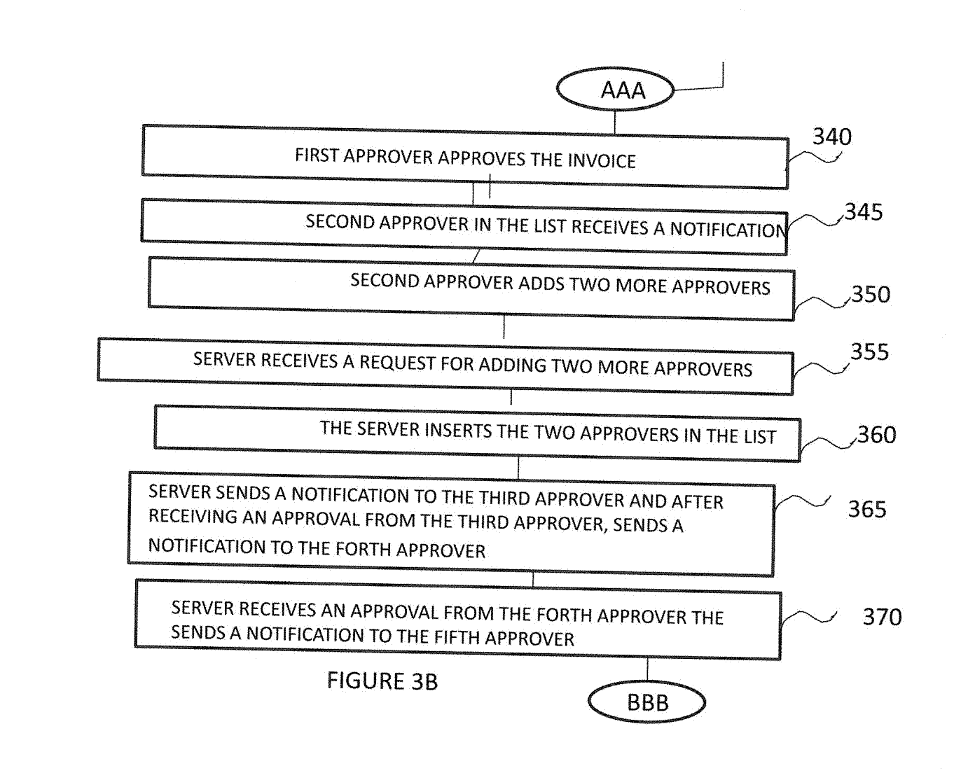

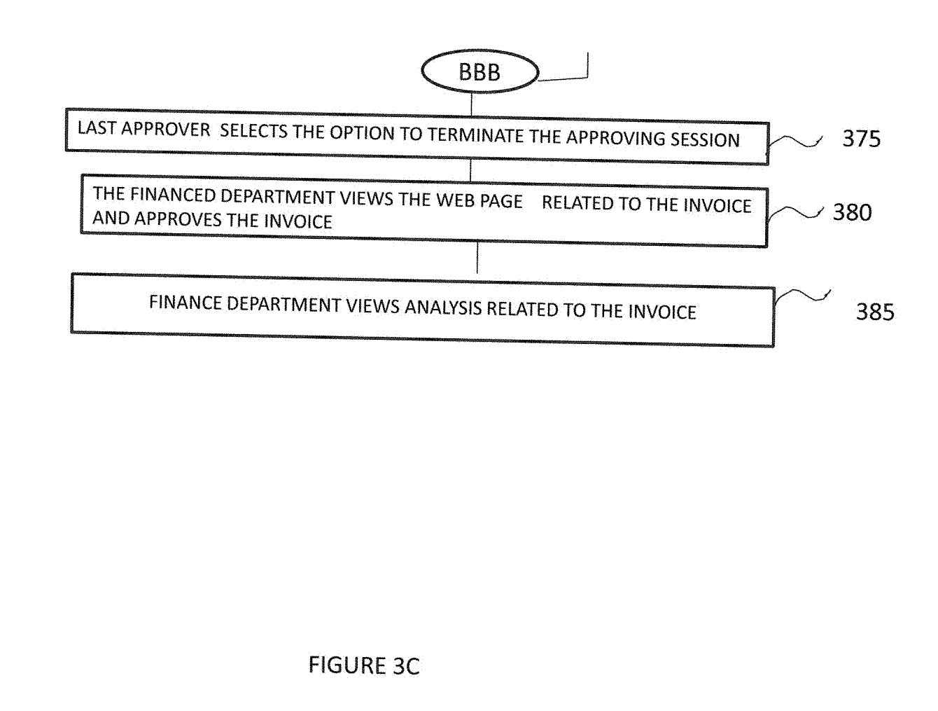

FIGS. 3a 3b and 3c show a flowchart diagram of a scenario of dynamic invoice approving in accordance with some exemplary embodiments of the disclosed subject matter;

At block 300, an image of the invoice is uploaded to the system.

At block 305, indexing process is performed. This indexing may include attaching identification to the document and extracting data from the invoice. Such data may include the amount to be paid, the name of the supplier, the name of the recipient etc.

At block 310, the invoice is sent to a dispatch tray. The dispatch tray is an inbox that can be accessed by a plurality of dispatching users that handle the invoice. Each user may select one or more invoices from the inbox to be handled by him. If one user asks to receive the next invoice, and the next invoice was or is being handled by another user, the system skips the next invoice and returns the successive invoice. These users may be responsible for dispatching the invoice to relevant approvers, or to index the invoice. The dispatcher decides whether to send the invoice directly to the recipient or to send the invoice to a person in the list of selected approvers.

At block 315, the first approver from the list of selected approvers receives a notification about an invoice to be approved. The user may receive the notification via email or check the inbox.

At block 320, the first approver opens the web page for handling the invoice.

At block 325, the first approver posts a question regarding the invoice and marks a specific region in the invoice. The question can be sent to multiple users. The first approver doesn't have to wait for an answer and can progress at any time.

At block 330, the first approver posts a “field update request” to one or more users, asking them to fill a required field (like order number for example).

At block 335, one of the users that receive the question (a responder) sends a response. The question and the response are available to all the users who handle this invoice via the history feed that is displayed upon displaying details of the invoice to the user. The history feed provides the users that handle the invoice the relevant information regarding the invoice approval process in natural business language describing all actions that took place by all users in the approval process. The history feed helps the users to understand how and why they received this invoice for approval and to make decisions regarding future required approvers. The history of all the questions, answers and field updates provide relevant information for the approval decision.

At block 340, first approver approves the invoice via the user UI.

At block 345, the second approver in the list receives a notification about an invoice to be approved.

At block 350, the second approver decides to add two more approvers after the third approver. It should be noted that the system suggests each approver to add more approvers to the list.

At block 355, a request for adding two more approvers is received at the server. The request is updated in the history feed of the invoice.

At block 360, the server inserts the two approvers in the list of approvers in a successive position to the third approver.

At block 365, the server sends a notification to the third approver and after receiving an approval from the third approver sends a notification to the fourth approver that has been added by the second approver.

At block 370, after receiving an approval from the fourth approver the server sends a notification to the fifth approver that has been added by the second approver and after receiving an approval from him, sends a notification to the last person in the list.

At block 375, the last approver selects the option of terminating the approving process (by approving the invoice and not adding more approvers to the list). The server inserts the invoice to a processor tray for providing the final approval. This tray behaves similarly to the dispatcher tray, but allowing processors (from the finance department) to retrieve invoices that need final approval and payment.

At block 380, the person from the finance department views the web page related to the invoice and based on the history feeds he approves the invoice.

At block 385, the person from the finance department (“manager”) views the analysis related to the invoices. Such analysis includes the time that elapse for each approver from the event of receiving an approval request the inbox to the event of approving the request, the time that has elapsed from the event of receiving a request for answering a question regarding an invoice to the event of responding to the question, total approving time, review the load on the users involved in the process, attention to VIP-marked documents, prediction of time a specific document will finish the approval process, etc.

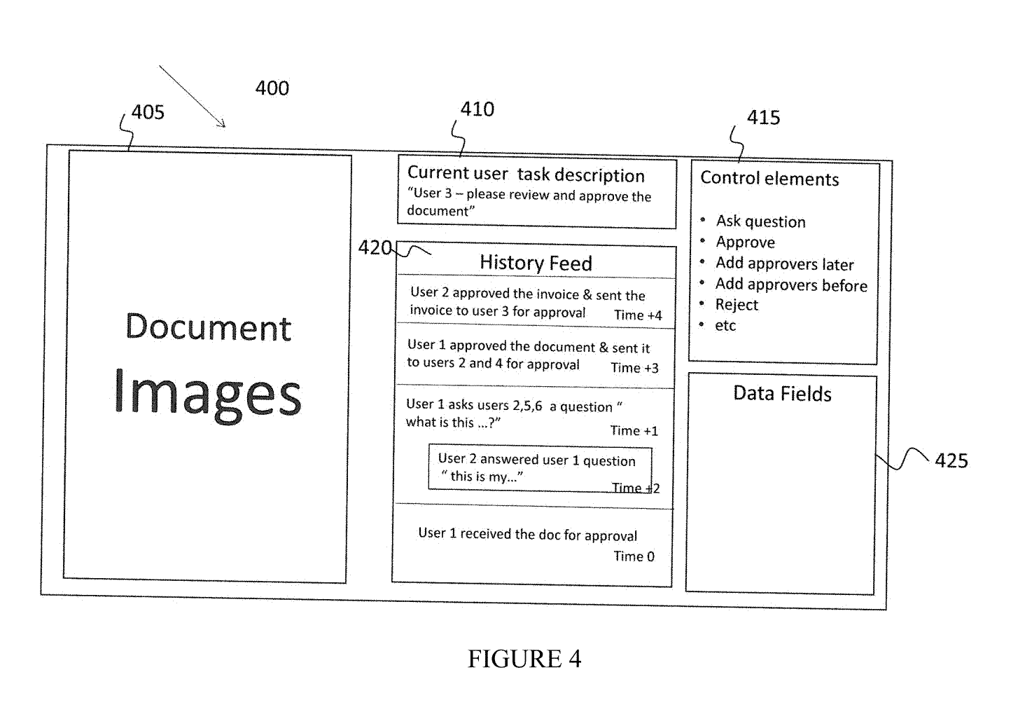

FIG. 4 shows an exemplary inbox item, in accordance with some exemplary embodiments of the disclosed subject matter.

Inbox item 400 includes document images 405, task description 410, control elements 415, history feed 420 and data fields 425.

Document images 405 include an image or images of the document.

The task description 410 includes a description of the task that has to be performed by the user that received the inbox item 400. Examples of such tasks are approving the document and responding to questions.

The control elements 415 enables the user to perform actions. Examples of such actions are approving, adding approvers to the list, rejecting the approval and post a question.

The history feed 420 records all the events that are related to the document. Examples of such events are approvals, adding approvers, posting queries and responding to queries.

The data fields 425 include fields that are extracted from the document.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium. Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like. Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A document approving method comprising: at a system having a server and a data repository; said data repository comprising data associated with a document, said data comprising an image of said document, a list of users and a list of selected approvers;
notifying a current approver about an approving request; wherein said current approver being selected from said list of selected approvers by an approval process; wherein said approval process traversing said list of selected approvers;
downloading to a computer device of said current approver said data associated with said document;
downloading to a computer device of said current approver control elements associated with said document; wherein said control elements being for selecting an approver from said list of users to be inserted in said selected approvers list; or wherein said control elements being for restarting said approval process from a certain position in said list of selected approvers; and
as a result of said notifying, receiving from said computer device a request for inserting a new approver in said selected approver list; said request comprises a position for inserting said new approver; and
in response to said request, inserting said new approver in said selected approvers list in accordance with said position, wherein a preceding position causing said approval process to restart said traversing from said preceding position, thereby causing said approval process to select said new approver as the current approver; and wherein a proceeding position causing said approval process to continue the traversing from a successive position to a position of said current approver and to eventually selecting said new approver as the current approver; or
as a result of said notifying, receiving from said computer device a request for reverting said approval process from a certain position in said list of approvers wherein said request causing said approving process to restart from said certain position.

2. The method of claim 1, wherein said document being an invoice.

3. The method of claim 2, further comprising automatic attaching a purchase order printout to the invoice screen as a result of entering a purchase order number matching said printout purchase order number.

4. The method of claim 1, further comprising presenting approvals, events, requests, questions and responses, related to said document in chronological order; wherein an answer being displayed next to question related to said answer.

5. The method of claim 1, further comprising providing a queue of a plurality of said documents for enabling the retrieving of said documents from said queue by a plurality of computer devices to be processes by a plurality of authorize person; and further comprising synchronizing the process to allow the processing of a single document by single person.

6. The method of claim 1, further comprising analyzing the history of approvals; said analyzing being for predicting time required to finalize the approval process.

7. The method of claim 1, wherein said notifying comprises inserting an inbox item to an inbox of said current approver and further comprising retaining said inbox item while current approver sends and receives messages related to said inbox and further comprising removing said inbox item from said inbox as a result of receiving an approval event from said approver and wherein task description of said inbox item being adapted to the approval event.

8. The method of claim 1, further comprising providing access right to a user from said list of users for reviewing information related to said document, wherein said access right being valid even after handling said document by said user.

9. The method of claim 1, wherein said notifying further comprising inserting an inbox item to an inbox of said current approver; wherein said downloading said data and said control elements being as a result of opening said inbox item by said current approver.

10. The method of claim 1 wherein said data further comprising, a list of questions asked by one or more of said users and a list of responses to said questions; and wherein the method further comprising;
notifying a user from said list of users about a question to be responded by said user, said question being associated with a document;
downloading to a computer device of said user said data associated with said document;
downloading to said computer device of said user control elements associated with said document, said control elements being for enabling said user to post a second question to a second user of said list of users; or to response to said question; and
as a result of said notifying, receiving from said computer device a request for posting said second question to said second user from said list of users, or, as a result of said notifying, receiving from said computer device a response to said question; and in response to said second question notifying said second question to said second user to thereby enabling said second user to reposed to said second question; or
as a result of said response associating said response with said document in said data repository thereby enabling users from said user list viewing said question and said response.

11. The method of claim 10, wherein said notifying said question further comprising a selected portion of said image of said document; wherein said selected portion being related to said question.

12. The method claim 10, wherein said notifying comprises adding an inbox item to an inbox of said user; and further comprising removing said inbox item from said inbox as a result of receiving said response.

13. The method of claim 10, wherein said document being an invoice.

14. The method of claim 12, wherein said downloading said data and said control elements being as a result of opening said inbox item by said user.

15. The method of claim 1, further comprising presenting to current viewer of said document actions related to said document taken by approvers until that time in chronological order wherein an answer being displayed next to a question being related to said question.

16. A document approving method comprising: at a system having a server and a data repository; said data repository comprising data associated with a document, said data comprising an image of said document, a list of users, a list of selected approvers, approval events, queries to a user from said users and responses to queries;
notifying a current approver about a request; and
downloading to a computer device of said current approver said data associated with said document; wherein said downloading enabling presenting said data in chronological order and further enabling presenting a response from said responses next to a query from said of queries; wherein said query being related to said response.

17. The method of claim 16, wherein said current approver being selected from said list of selected approvers by an approval process; wherein said approval process traversing said list of selected approvers.

18. A non-transitory computer-readable storage medium for storing instructions, the instructions when executed by a processor, at a system having a server and a data repository; said data repository comprising data associated with a document, said data comprising an image of said document, a list of users and a list of selected approvers, causes the processor to:
notifying a current approver about an event of approving request; wherein said current approver being selected from said list of selected approvers by a traversing process;
downloading to a computer device of said current approver said data associated with said document;
downloading to a computer device of said current approver control elements associated with said document; wherein said control elements being for enabling said current approver to approve said document; wherein said control elements being for selecting an approver to be inserted in said selected approvers list; wherein said selecting being from said list of users and
as a result of said notifying, receiving from said computer device a request for inserting a new approver in said selected approver list; said request comprises a position for inserting said new approver; and
in response to said request, inserting said new approver in said selected approvers list in accordance with said position, wherein a preceding position causing said traversing process to continue the traversing from said preceding position, thereby to select said new approver as the current approver; and wherein a proceeding position causing said traversing process to continue the traversing from a successive position and to eventually selecting said new approver as the current approver.
